(19) United States
(12) Patent Application Publication
(10) Pub. No.: US 2005/0276679 A1
(43) Pub. Date: Dec. 15, 2005

(54) Automated reserved article delivery system and method

(76) Inventor: Mark R. Frich, Maplewood, MN (US)

Correspondence Address: ROBERT A PAJAK;PATENT SERVICES, 14234 NAPLES STREET NE, HAM LAKE, MN, 55304, US

(21) Appl. No.: 10/857,986

(22) Filed: May 29, 2004

(51) Int. Cl. B65G 1/00

(52) U.S. Cl. 414/273

(57) ABSTRACT

A reserve system for library articles includes (i) a “reserved article” storage system for temporarily storing and automatically retrieving reserved articles, (ii) a conveyance to deliver the library articles to either the library staff or an originating library patron, and (iii) at least one controller system to manage all system functions. The reserved article storage system may be a modular system that includes: (i) one or two “storage racks,” each comprised of a plurality of “storage bins” for temporary article storage, and (ii) one “vertically positionable retrieve and transport assembly” for article retrieval from a selected storage bin from a selected storage rack. The vertically positionable retrieve and transport assembly includes one or more “pusher mechanisms” to push any articles in a selected storage bin from the storage bin to a “horizontal rack transport assembly” to move articles from the vertically positionable retrieve and transport assembly onto a conveyance mechanization or system such as delivery from a kiosk or integrated library system. The conveyance may include selected conveyors to transport the articles in an orderly manner to a re-circulation bin or to a patron remote from the reserved article storage system.

### RELATED APPLICATION

This application claims the benefit of priority pursuant to 35 USC 119 of provisional patent application Ser. No. 60/474, filed 30 May 2003 , the disclosure of which application is hereby incorporated in its entirety by reference herein.

### FIELD OF THE INVENTION

The present invention relates generally to patron requested article handling systems, and more particularly to an automated reserved article delivery system and method, and more particularly to a library patron reserved article delivery system and method that permits patron self-check-out & check-in of library patron reserved articles.

### BACKGROUND OF THE INVENTION

Modern libraries have experienced increased demands from patrons, in terms of needs for larger and larger holdings of books and other tangible materials. Accordingly, it is not uncommon for public libraries, for example, to handle collection and distribution of hundreds of thousands, or even millions, of books and materials. Tasks of librarians in handling these ever-increasing volumes are often overwhelming. Herein, a library's collection is referred to as articles, including among others, books, video and audio tapes and CDs, pamphlets, magazines and the like.

Particularly problematic librarian tasks involve both receiving materials returned from, and distributing materials to, patrons. These tasks (commonly referred to as “check-in” and “check-out”, respectively) when manually performed by library personnel upon such ever-growing volumes of books and other library-like materials, greatly affects time required to repetitively collect and distribute each library article or material, i.e., “turn-around time”0 is negatively impacted.

Advanced library article material handling systems and methods have been disclosed in U.S. Pat. No. 6,561,418 entitled “Check-out system for library-like materials,” U.S. Pat. No. 6,557,696 entitled “Inclined conveyor,” U.S. Pat. No. 6,422,457 entitled “Access device for a materials depository,” U.S. Pat. No. 6,257,816 entitled “Book binding orientation detector,” U.S. Pat. No. 6,203,262 entitled “Cart loading system and method for library-like materials,” U.S. Pat. No. 6,074,156 entitled “Library cart loading system and method,” and U.S. Pat. No. 6,000,770 entitled “Library book bin with a vertically adjustable floor.” These aforementioned patents are incorporated herein by reference, and exhibit state of the art library article handling systems including re-circulation sorting and re-shelving assistance operations.

Libraries generally have two basic methods to allow checkout of library articles. One is for the patron to manually or physically select and checkout the article. Another is to allow the patron to place the article on a request or reservation list for later retrieval.

Such a reservation list allows the patron to request an article without actually being in the library. For example, an article may be a requested over the telephone or internet. In response to requests for articles, a “paper” list may be generated, and in turn, a library worker would retrieve the requested article and place the requested article in a designated location for the patron to pick up at another time. Further, the library worker also records the date of the initial reservation of the article. If the reserved article is not picked up within a specified time, for example ten days, the library staff will return the article to the library shelves to be available for other patrons.

It should be noted that a patron may request articles that have been already checked out, in which case the request is subsequently placed on a “waiting list” for subsequent notification to the patron for availability at a designated time or requested location.

Present day libraries require the patron to enter the library to claim and checkout the reserved article only during normal operating hours. The separation of material for restocking, the retrieval of the reserved material for the patron, and the normal checkout system makes the present day reserved checkout method inconvenient for the patron as well as time-consuming for the library staff. It should be noted that institutions and businesses other than libraries engage in patron article reservation and check-out tasks as well having similar problems and needs. For example, videotape rental facilities handle large amounts of library-like materials in forms of videotapes, videodisks, audio and video cassettes and the like.

Attempts to respond to needs for automation of these check-out and reservation tasks, several techniques, devices, and systems have been proposed. Yet, there remains a need for a system that provides automation of reservation and check-out tasks of library-like materials or articles that does not depend on the involvement of the library staff to retrieve reserved articles for check-out and permits patron checkout without library staff involvement or physically being within the library during normal operating hours.

### SUMMARY OF THE INVENTION

An object of the present invention is to provide an automated library article patron reserve system and method.

An object of the present invention is to provide a system that permits a patron to pick up reserved library articles at times other than library operating hours.

Another object of the present invention is to provide a system that retrieves and delivers reserved library articles to a patron that is located outside the library structure.

Another object of the present invention is to provide an automated library article patron reserve system and method that permits the tracking of library articles for restocking and separates said articles for pick-up by the library staff.

Another object of the present invention is to provide an automated library article patron reserve system and method configuration that accommodates a stand-alone kiosk implementation that permits a patron to access reserved library articles at designated remote locations from the library.

In accordance with the present invention a reserved article delivery system for library-like materials, or simply library articles—hereafter referred only to as “articles,” includes (i) a “reserved article” storage system for temporarily storing and automatically retrieving reserved articles, (ii) a conveyance to deliver the library articles to either the library staff or the library patron, and (iii) at least one controller system to manage all system functions. The reserved article storage system may be a modular system that includes: (i) one or two “storage racks,” each comprised of a plurality of “storage bins” for temporary article storage, and (ii) one “vertically positionable retrieve and transport assembly” for article retrieval from a selected storage bin from a selected storage rack. The vertically positionable retrieve and transport assembly includes one or more “pusher mechanisms” to push any articles in the selected storage bin from the storage bin to a “horizontal rack transport assembly”0 to move articles from the vertically positionable retrieve and transport assembly onto a conveyance mechanization or system such as delivery from a kiosk or integrated library system. The conveyance may include selected conveyors to transport articles in an orderly manner to a re-circulation bin or to a patron located remote from the reserved article storage system, e.g., outside the library building.

### BRIEF DESCRIPTION OF THE DRAWINGS

FIG. 1 is a perspective view illustration of a reserved article storage and retrieval system in accordance with the present invention.

FIG. 1B is a further perspective view illustration of FIG. 1 with included detail of a vertically positionable retrieve and transport assembly, sensors, drive system, and horizontal rack transport assembly in accordance with the present invention.

FIG. 1C is a further perspective view illustration of FIG. 1B with included detail of doors and door interlocks in accordance with the present invention.

FIG. 1D is side view illustration of a reserved article storage and retrieval system in accordance with the present invention.

FIG. 1E is a profile view of a storage bin in accordance with the present invention.

FIG. 2A is a perspective view illustration of an exemplary embodiment of a reserve article storage system in accordance with the present invention attached to a conveyance for article transport.

FIG. 2B is a plan view illustration of a reserve article storage system in accordance with the present invention attached to a conveyance for article transport.

FIG. 2C is a side view illustration of a reserve article storage system in accordance with the present invention attached to a conveyance for article transport.

FIG. 3 is a schematic block diagram in accordance with the present invention.

FIG. 4 is a schematic flow diagram illustrating a control scheme for temporary storage of reserved library articles in accordance with the present invention.

FIG. 5 is a schematic flow diagram illustrating a control scheme for the retrieval of reserved library articles by a library patron in accordance with the present invention.

FIG. 6 is a schematic flow diagram illustrating a control scheme for the manual purging of reserved library articles from the storage bins in accordance with the present invention.

FIG. 7 is a schematic flow diagram illustrating a control scheme for the automatic purging of reserved library articles from the storage bins in accordance with the present invention.

FIG. A1 is a photograph of a perspective of vertically positionable retrieve and transport assembly and storage rack.

FIG. A2 is a photograph of article pusher assembly and shelves.

FIG. A3 is a photograph a perspective of storage rack and horizontal rack transport/transport conveyor assembly.

FIG. A4 is a photograph of drive chain and sprocket assembly for positioning the vertically positionable retrieve and transport assembly.

FIG. A5 is a photograph of a guide and drive chain for the vertically positionable retrieve and transport assembly.

FIG. A6 is a photograph of a horizontal transport drive assembly.

FIG. A7 is a photograph of a front perspective of an article pusher assembly.

FIG. A8 is a photograph of a rear perspective of an article pusher assembly.

FIG. A9 is a photograph of front view of the article pusher assembly.

FIG. A10 is a photograph of the system of the present invention

FIG. A11 is a photograph of a track guide for vertically positionable retrieve and transport assembly.

FIG. A12 is a photograph of group of interconnected rack assemblies.

FIG. A13 is a photograph of end view of the horizontal rack transport.

FIG. A14 and A15 are photographs of perspective view of directional conveyance transport system.

FIG. A16 is a photograph of a horizontal belt conveyor.

FIG. A17 and A18 are photographs of a two directional endless belt system.

FIG. A19 is a photograph of transport conveyors.

FIG. A20 is a photograph of collection re-shelving and re-circulation bin.

FIG. A21 is a photograph of transport conveyors.

FIG. A22 is a photograph of transport conveyors.

### DETAILED DESCRIPTION OF THE INVENTION

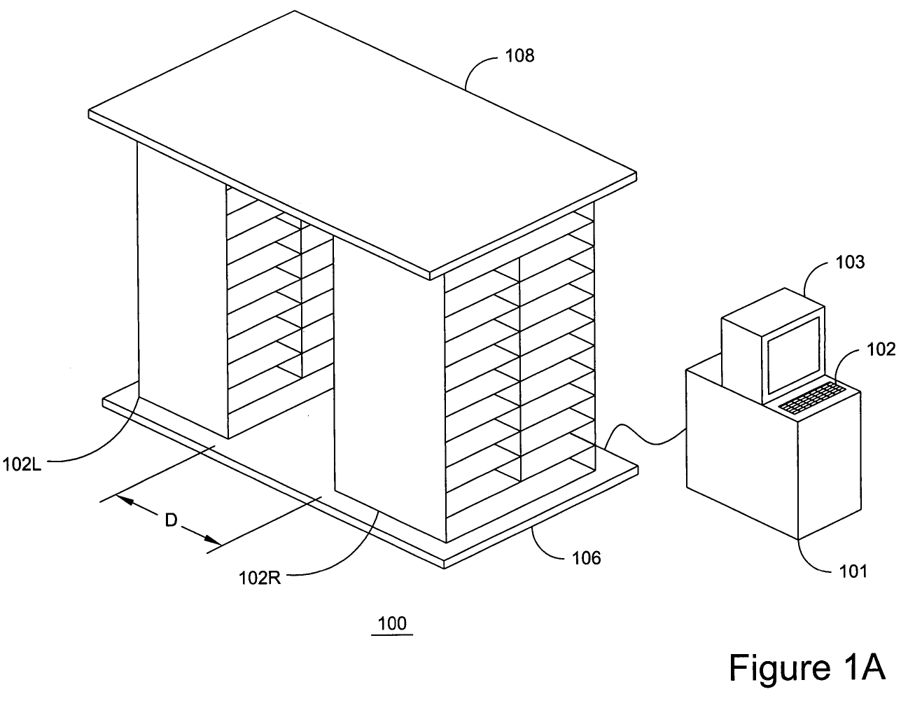

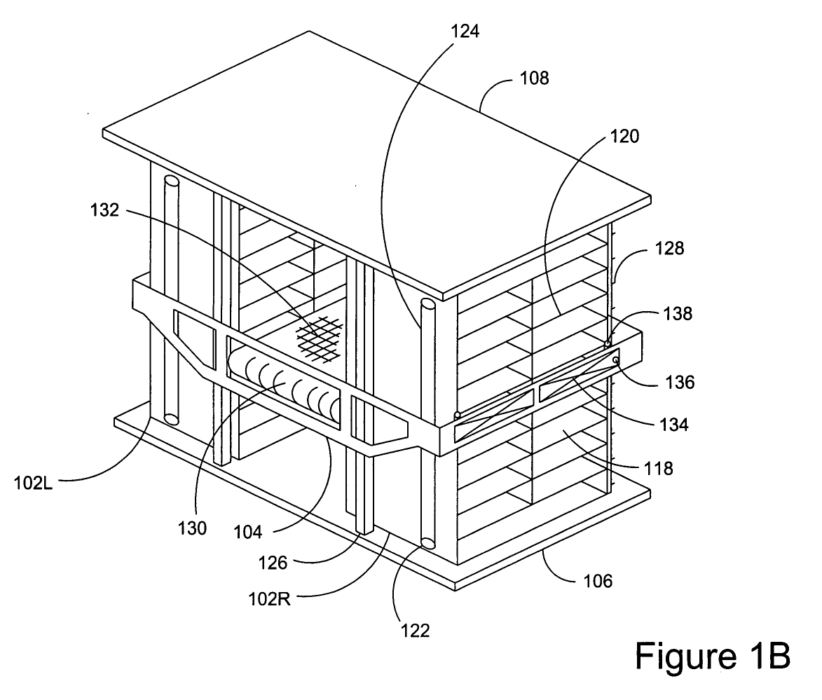

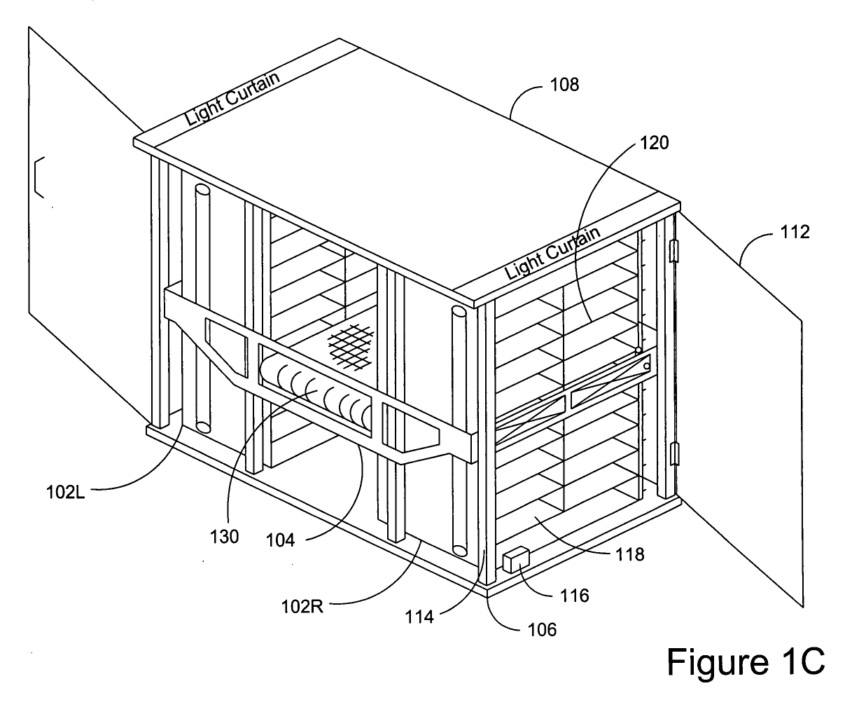

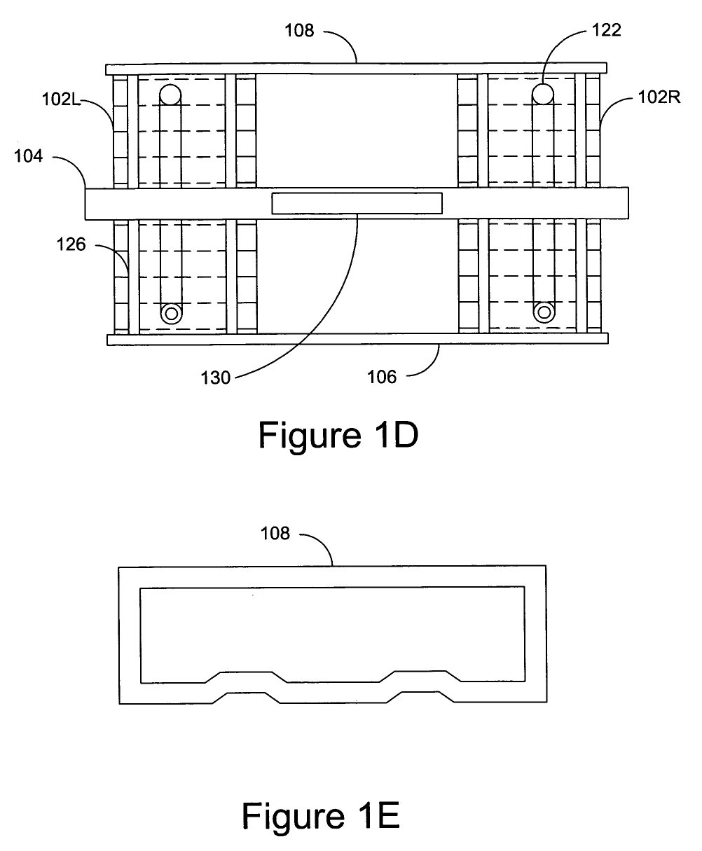

In the following exposition, the words “book”, “material”, “article”, and “library-like material” as used herein are synonymous, and are intended to include, among others, (i) any conventional library material such as, but not limited to, a bound book, a “paperback” book, a materials container (such as a magazine series receptacle or holder), a diskette cassette, a video tape, or (ii) any other tangible media that may have dimensions or an outward appearance somewhat similar or analogous to a conventional book. Illustrated in FIGS. 1A-1E are various views of an exemplary embodiment of a reserved article delivery system that provide an overall general description of certain components of the exemplary system in accordance with the present invention.

FIG. 1A illustrates a perspective view of an exemplary embodiment of a reserve article storage rack assembly 100 in accordance with the present invention. Associated with rack assembly 100 is an overall system controller 101 with keyboard 102 and display console 103. As illustrated therein, rack assembly 100 includes two storage racks 102L and 102R. Rack assembly 100 also includes an integrated vertically positionable retrieve and transport assembly 104 including horizontal transport assembly 130 as will be further described. Rack assembly 100 also includes a bottom panel 106 and a top panel 108. It should be noted that storage racks 102L and 102R are separated by a distance “D” as illustrated so as to accommodate horizontal transport assembly 130.

Each storage rack 102L,R includes an array 120 of storage bins or slots 118 for the placement therein of reserved library articles. It should be evident that the number of vertical columns and horizontal rows comprising array 120 may vary. Further, the length and height of each bin 118 is dependent upon the size of the article intended for storage and may also vary. As will be further described and as illustrated in FIGS. 1A-1D, each bin 118 has specific features to permit complete article removal and to prevent jamming of any article(s) within bin 118.

FIG. 1B is a further perspective view illustration of FIGS. 1 and 1D with included detail of vertically positionable retrieve and transport assembly 104, control system sensors, drive system, and horizontal rack transport assembly in accordance with the present invention. Each rack assembly 100 includes a drive system 122 to provide for the vertical translation of said vertically positionable retrieve and transport assembly 104. With regard to details of drive system 122, it is illustrated in FIG. 1B as a conventional chain-and-sprocket drive (drive motors and associated hardware are not illustrated for simplicity and clarity of the drawings.) Any suitable type of drive system 122 may, however, be employed. In an exemplary embodiment, a drive scheme is provided by way of conventional chain drive means, including a conventional drive motor (not illustrated) coupled to chain 124 as recognized by those of ordinary skill in the art.

In exemplary embodiment of the invention, travel of vertically positionable retrieve and transport assembly 104 is guided by conventional rollers and track. Any suitable type of guidance may, however, be employed. More specifically in this embodiment, rollers (not illustrated) are mounted on vertically positionable retrieve and transport assembly 104 and track 126 is attached to storage rack 102 as recognized by those of ordinary skill in the art.

As will be further described, included on storage rack 102 are index features 128 to indicate the location of each row of array 120. Index features 128 are located at an elevation corresponding to each row of array 120. To be more specific, the vertical spacing of each index feature 128 is equal to the spacing of each horizontal row of bins 118 in array 120.

Vertically positionable retrieve and transport assembly 104 includes a horizontal transport assembly 130 . With regard to details of transport assembly 130, conveyor belt 132 as illustrated in FIGS. 1B and 1D is a conventional motorized belt conveyor (drive motors and associated hardware are not illustrated for simplicity and clarity of the drawings.) Any suitable type of conveyance scheme may, however, be employed. In an exemplary embodiment, a drive scheme may be provided by way of any conventional belt drive means, including a conventional drive motor (not illustrated) coupled to belt 132, as recognized by those of ordinary skill in the art.

Vertically positionable retrieve and transport assembly 104 further includes one pusher assembly 134 for each column of array 120. Upon command from system controller 101, pusher assembly 134 extends into bin 118 and pushes the article within bin 118 onto conveyor 130. As will be further described, each pusher assembly 134 has specific features to permit complete article removal and to prevent jamming of the article in bin 118.

With regard to details of pusher assembly 134, pusher assembly 134 as illustrated in FIGS. 1B-D is a conventional scissors jack (drive motors and associated hardware are not illustrated for simplicity and clarity of the drawings). In an exemplary embodiment, an extension scheme may be provided by way of any conventional extension means, including a conventional scissors jack and drive motor (not illustrated), as recognized by those of ordinary skill in the art. In this exemplary embodiment of the present invention, pusher assembly 134 includes a base, a pusher face, a driving mechanism and a scissors jack mechanism for extension.

With regard to further detail of the pusher assembly 134 and bin 118, pusher assembly 134 and bin 118 included features to assure complete article removal and to minimize jamming. In an exemplary embodiment of the present invention, pusher assembly 134 and bin 118 have matching perimeter profiles. To be more specific, the bottom face of the rectangular perimeter profile of bin 118 is keyed with a channel profile. Illustrated in FIG. 1E is an exemplary embodiment of the aforesaid profile features. Pusher assembly 134 is similarly keyed (not illustrated) with a ridge to mate with the channel keyway of bin 118 illustrated in FIG. 1E. Other channel keyway features may accomplish the same result in other configurations, as recognized by those of ordinary skill in the art

Vertically positionable retrieve and transport assembly 104 further includes sensors 136 to detect the location of each row of bins 118 as indicated by said index feature 128. During translation of vertically positionable retrieve and transport assembly 104, as sensors 136 pass each index feature 128, a signal is sent to system controller 101. Each signal transmission is counted thereby allowing for the vertical position of vertically positionable retrieve and transport assembly 104 to be determined by system controller 101.

Further, vertically positionable retrieve and transport assembly 104 has an angled leading edge (not illustrated) to reposition articles that overhang storage bin 118 by an allowable distance controlled by the geometry of said angled leading edge. Vertically positionable retrieve and transport assembly 104 also includes article overhang sensors 138 to detect articles that exceed the allowable overhang distance just described. As described herein, during operation vertically positionable retrieve and transport assembly 104 moves past array 120. If an article stored in any bin of array 120 is not fully inserted into bin 118 and overhangs by a distance less than that allowed by the design of said angled leading edge, the angled leading edge will push the article into bin 118. If an article stored in bin 118 is not fully inserted into bin 118 and exceeds the allowable overhang distance of said angled leading edge, article overhang sensors 138 will be send a signal to system controller 101 and power to the drive mechanism will be shut off. Movement of vertically positionable retrieve and transport assembly 104 will subsequently stop.

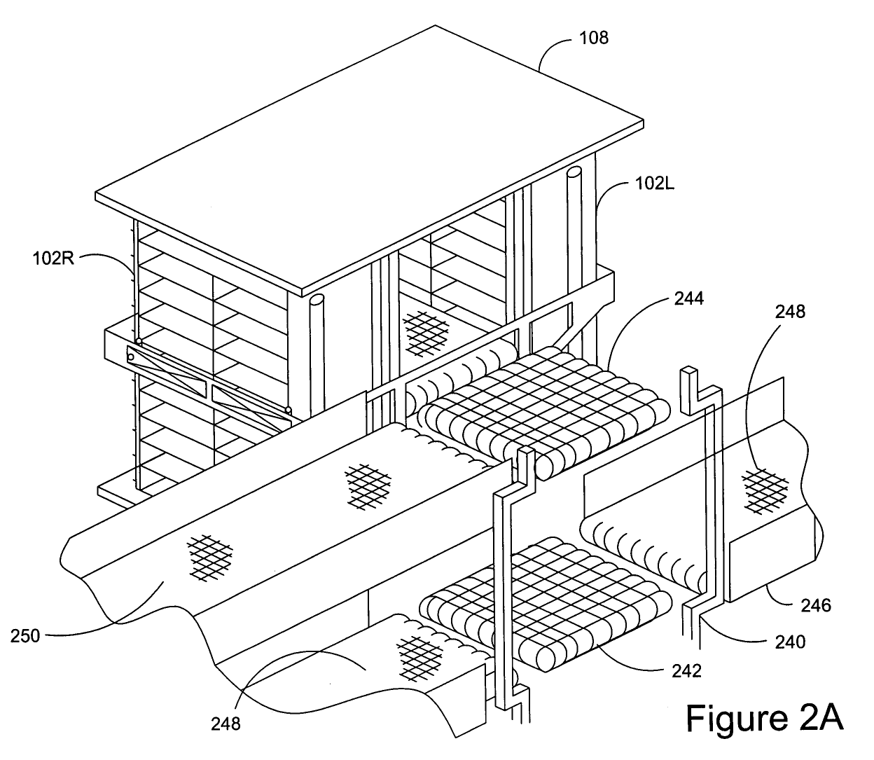

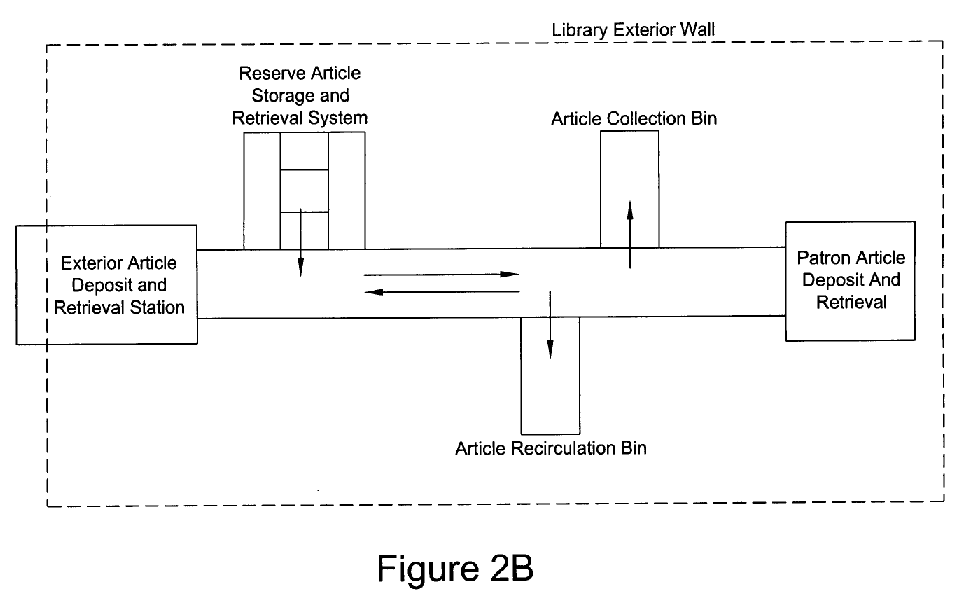

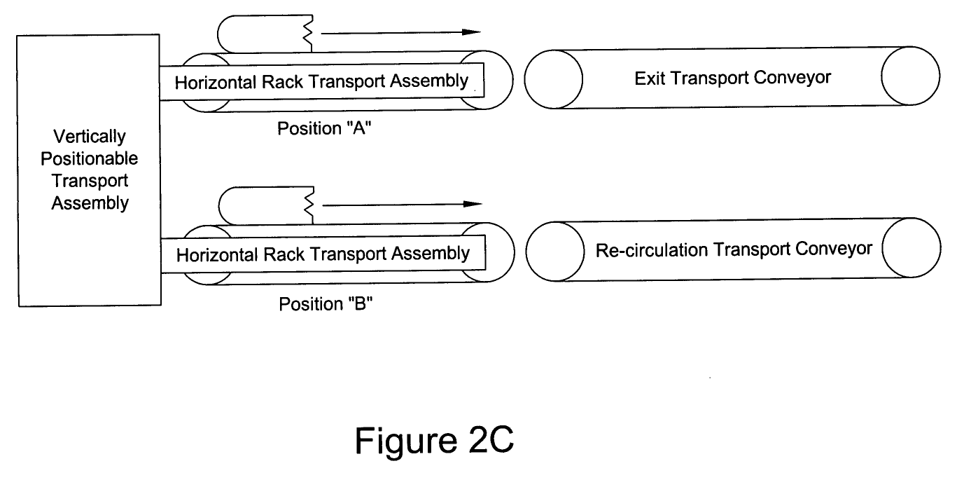

FIG. 2A is a perspective view illustration of an exemplary embodiment of rack assembly 100 coupled to a double layer transport conveyor assembly 240. Conveyor assembly 240 includes two levels of belt conveyors 242 and 244. Each level is comprised of two perpendicular sets of endless belts thereby providing each belt conveyor 242 and 244 with two-directional conveyance. With regard to details of conveyor assembly 240, re-circulate conveyor 242 and exit conveyor 244 as illustrated in FIG. 2 are conventional two-directional motorized belt conveyors (drive motors and associated hardware are not illustrated for simplicity and clarity of the drawings.) Any suitable type of conveyance scheme may, however, be employed. In an exemplary embodiment of the present invention, a drive scheme may be provided by way of any conventional belt drive means, including a conventional drive motor (not illustrated) coupled to conveyors 242 and 244 as recognized by those of ordinary skill in the art.

Conveyor assembly 240 is connected to transport system 246. Transport system 246 includes a re-circulate conveyor belt 248 aligned with re-circulate conveyor 242 and is an exit conveyor belt 250 aligned with exit conveyor 244. With regard to details of transport system 246, re-circulate conveyor belt 248 and exit conveyor belt 250 as illustrated in FIG. 2 are conventional motorized belt conveyors (drive motors and associated hardware are not illustrated for simplicity and clarity of the drawings.) Any suitable type of conveyance scheme may, however, be employed. In an exemplary embodiment, a drive scheme may be provided by way of any conventional belt drive means, including a conventional drive motor (not illustrated) coupled to belts 248 and 250, as recognized by those of ordinary skill in the art.

Illustrated in FIG. 2B is an exemplary illustration of a rack assembly 100 in accordance with the present invention attached to a conveyance for article transport. Also shown are re-circulation bins and collection bins.

As will be further described, FIG. 2C is a side view illustration of a reserve article storage system in accordance with the present invention attached to a conveyance for article transport.

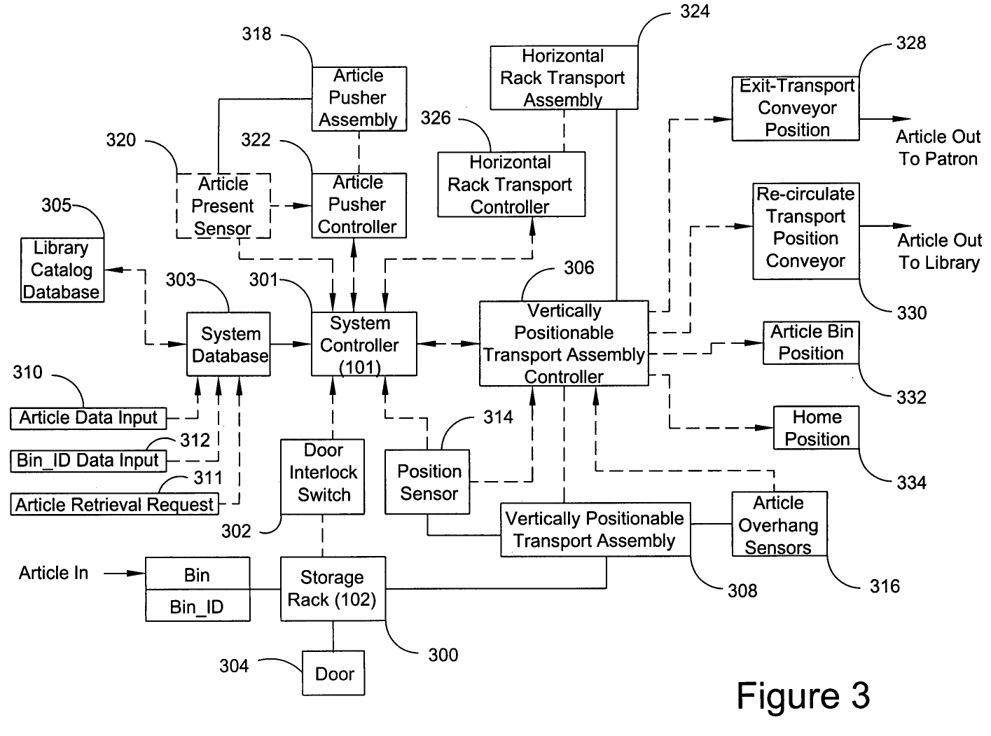

FIG. 3 is a block diagram of an exemplary system of the present invention. Before proceeding it is presumed that a library patron requests to reserve an article for later “check-out,” library personnel retrieve the requested article and take the article to the reserve article storage system aforedescribed. At system controller console 103, the operator initiates “Load Mode.” The operator enters the article ID (block 310) and the storage bin ID (block 312) into system controller 101 database. The system operator then places the article into a selected storage bin having a dedicated, unique storage bin_ID within storage rack 102 (block 300.) The reserved articles remain stored in rack 102 until (i) a patron initiates the retrieval process or (ii) the system is instructed to initiate a “manual purge” process or (iii) the system detects an expired reservation and initiates an “automatic purge.”

As will be further detailed, there are five basic operating modes of the present invention. These are “Standby Mode”, “Load Mode”, “Retrieval Mode”, “Manual Purge Mode”, and “Auto Purge Mode.”

“Standby Mode” indicates that the system is awaiting instruction from either a patron or a library staff member. As will be described, if all doors (block 304) and interlocks (block 302) are closed and article overhang sensors (block 316) indicate an absence of any obstructions, the system is operable. When the system is taken out of “Standby Mode” by either a patron retrieval request or by an instruction to “purge” the transport assembly controller (block 306) will instruct the vertically positionable retrieve and transport assembly 104 (block 308) to move to the appropriate bin_ID. While moving, the position sensor 136 (block 314) will provide positional data to the controller (block 306.)

When a count of signals from sensor 136 indicates that the correct vertical location has been reached, the controller will stop the vertically positionable retrieve and transport assembly. The article pusher controller (block 322) will instruct the pusher assembly (block 318) to fully extend and retract. Article present sensor (block 320) will signal to the controller if an article was or was not in the bin. If an article was pushed from bin 118, system controller 101 will instruct the vertically positionable retrieve and transport assembly to re-position to either the exit-transport conveyor (position “A” in FIG. 2A-2) or the re-circulate transport conveyor (position “B” in FIG. 2A-2) elevation. When a count of signals from position sensor 136 indicates that the correct vertical location has been reached, the controller will stop the vertically positionable retrieve and transport assembly. When vertical travel has stopped, the horizontal rack transport controller (block 326) will instruct the horizontal rack transport (block 324) to power “on” thereby moving the article to either exit-transport conveyor 250 (block 328) or re-circulate transport conveyor 248 (block 330.)

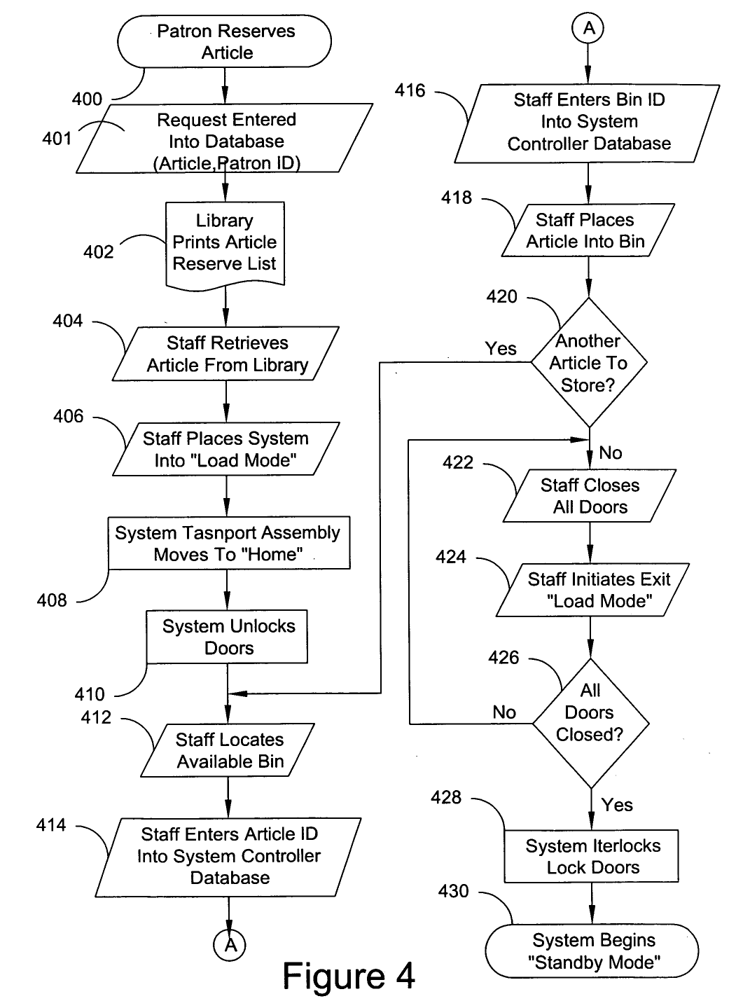

FIG. 4 is a schematic flow diagram illustrating a control scheme for the temporary storage of reserved library articles in accordance with the present invention. When a patron reserves an article (block 400) the request is entered into a database (block 401). A list of reserved articles subsequently is printed out (block 402) upon demand or periodically. The requested article is retrieved from the library circulation storage (block 404.) The article is taken to controller 101 described herein. At controller 101 the operator places rack assembly 100 into “Load Mode” (block 406.) Upon initiation of “Load Mode,” the vertically positionable retrieve and transport assembly 104 is re-positioned to a predetermined “home ”location (block 408). This “home” position will preferably be at an extreme end of travel for vertically positionable retrieve and transport assembly 104. The “home” position is acquired to maximize access to storage bins 118 and to assure safe access to bins 118 by library staff.

Referring to FIG. 1C, rack assembly 100 also includes a door 112, attached to doorframe 114, to cover the outward-facing side of each storage rack 102. With regard to user safety, each door 112 is locked by means of an interlock mechanism 116 to cut power to vertically positionable retrieve and transport assembly 104 when door 112 is not closed. Once the vertically positionable retrieve and transport assembly 104 is at the “home” position, the door interlocks 116 will open (block 410) thereby interrupting power to vertically positionable retrieve and transport assembly 104 and unlocking cabinet doors 112 to allow access to the storage bins 118.

In turn, the library employee takes the article to be reserved to the reserve article storage system and fully opens the door 112 allowing full access to all the bins. The operator locates an available bin 118 for the article (block 412) and enters the article ID (block 414) and the chosen bin ID (block 416) into the system controller 101. The article ID and Bin ID are now associated with a particular patron request and will remain associated until either a “purge” or “retrieval” of the article, to be further described, is completed.

The library employee then places the article into the selected bin 118 (block 418.) If there is another article to be stored (block 420), the library employee locates another bin 118 and the process heretofore described is repeated. If no additional articles are to be stored in bin array 120, the library employee closes (latches) all doors 112 (block 422) and exits “Load Mode” (block 424). If all doors 112 are securely closed and latched (block 426), the door interlocks 116 will re-activate and power will return to vertically positionable retrieve and transport assembly 104 (block 428.) The system will then resume “Standby Mode” (block 430.)

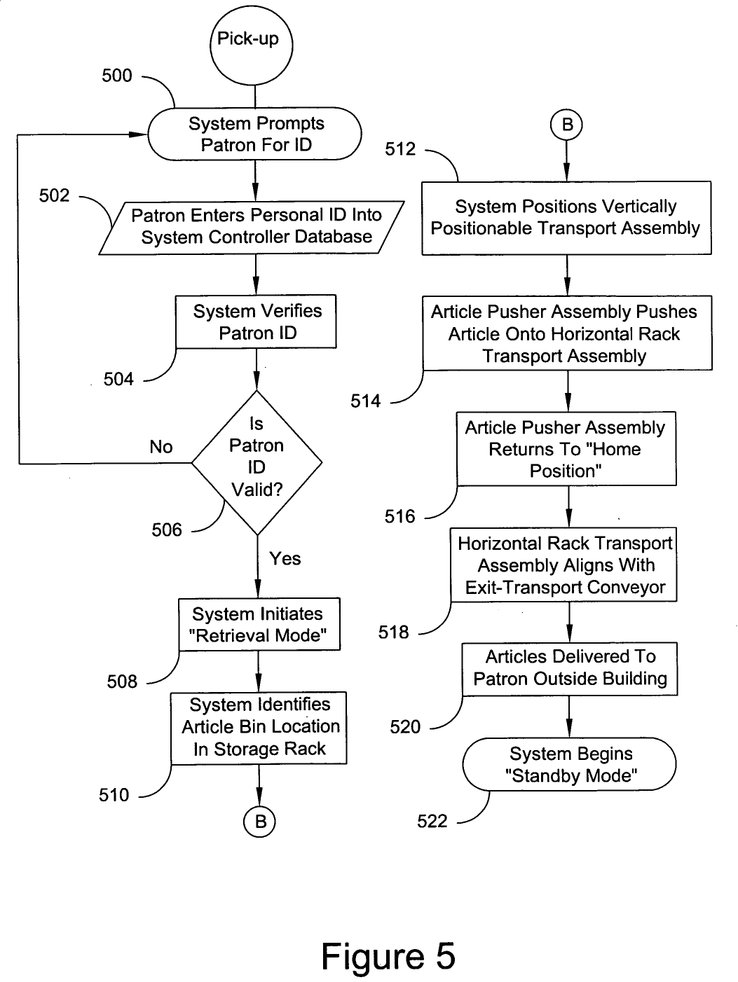

FIG. 5 is a schematic flow diagram illustrating a control scheme for the retrieval of reserved library articles by a library patron. With the system in “Standby Mode,” a library patron initiates the system and the patron is prompted by the control system to supply proper identification (block 500). The patron will supply ID (block 502) and the system will verify the patron's ID (block 504) by way of a library card having a bar code, RFID tag, smart card, or the like. If the ID is valid (block 506) and an article has indeed been reserved (the flowchart assumes this to be true), the system will initiate “Retrieval Mode” (block 508.) The system controller 101 identifies the article bin location (block 510.) The system controller 101 causes the vertically positionable retrieve and transport assembly 104 to be positioned so as attain alignment between pusher 134 and the designated or requested bin (block 512.) The system controller 101 instructs pusher 118 to push the article out of the designated bin (block 514), and returns to its “home” position (block 516.)

In turn, controller 101 positions vertically positionable retrieve and transport assembly 104 align horizontal transport assembly 130 with exit conveyor 244 (block 518.) Conveyor 244 transports the article to the waiting patron (block 520.) Upon delivery to the patron, the system returns to “Standby Mode” (block 522) after all requested articles have been delivered.

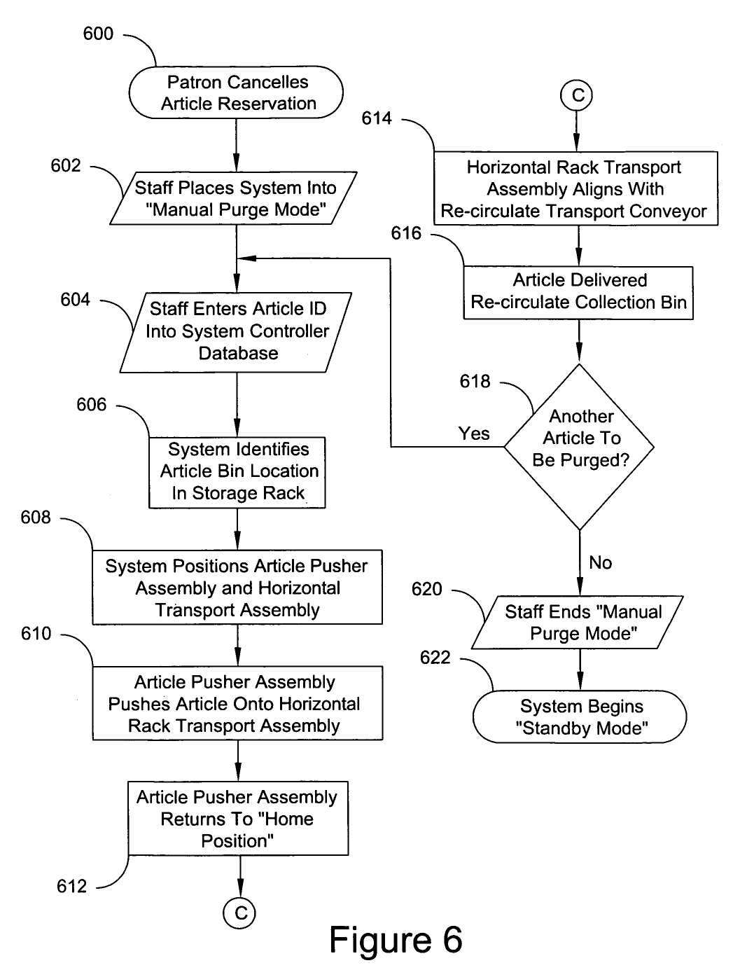

FIG. 6 is a schematic flow diagram illustrating a control scheme for the manual purging of reserved library articles from storage bins 118. FIG. 6 is an exemplary schematic of the process initiated by the cancellation of a reservation by a patron (block 600.) It is to be appreciated that the general process for manual purging is similar to a patron request as illustrated in FIG. 5. A system operator initiates “Manual Purge Mode” (block 602.) The system or staff may automatically identify the ID of the article to be purged into the system controller 101 database (block 604.) System controller 101 positions the vertically positionable retrieve and transport assembly 104 to attain alignment of pusher 134 and bin 118 (block 608) as before. The system controller 101 instructs pusher 134 to push the article out of bin 118 (block 610.) Pusher 134 returns to its “home” position (block 612.) The system controller 101 identifies the article bin location (block 606.) System controller 101 causes the vertically positionable retrieve and transport assembly 104 to be positioned so as attain alignment between pusher 134 and the designated or requested bin (block 512.) System controller 101 instructs pusher 118 to push the article out of the designated bin (block 514), and returns to its “home” position (block 516.) Vertically positionable retrieve and transport assembly 104 moves to attain alignment between the horizontal transport assembly 130 with exit conveyor 242 (block 614.) Conveyor 242 transports the article to conveyor 248. Conveyor 248 is intended to transport the article to a re-circulation collection bin (block 616.) If there is another article to be purged (block 618), the library staff enters new article ID to repeat the sequence of events. If there are no additional articles to be purged, the system operator ends “Manual Purge Mode” (block 620) and the system returns to “Standby Mode” (block 622.)

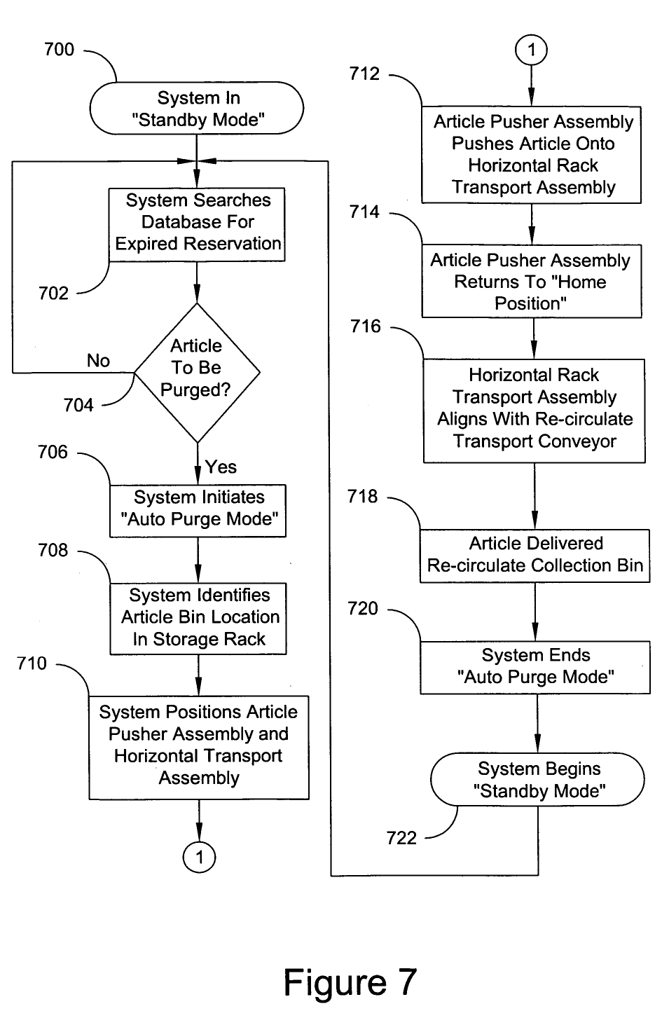

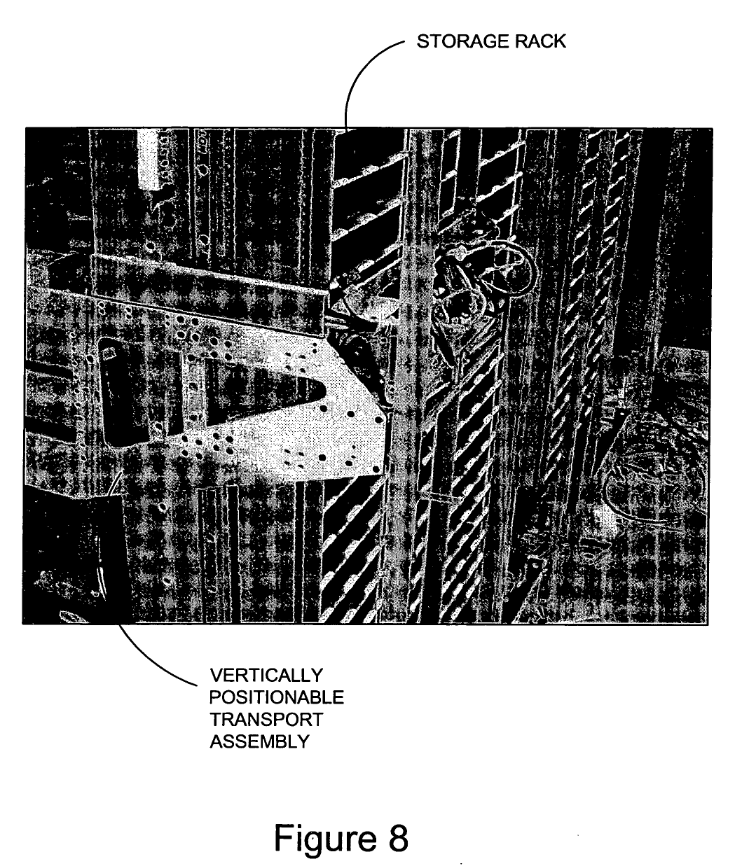

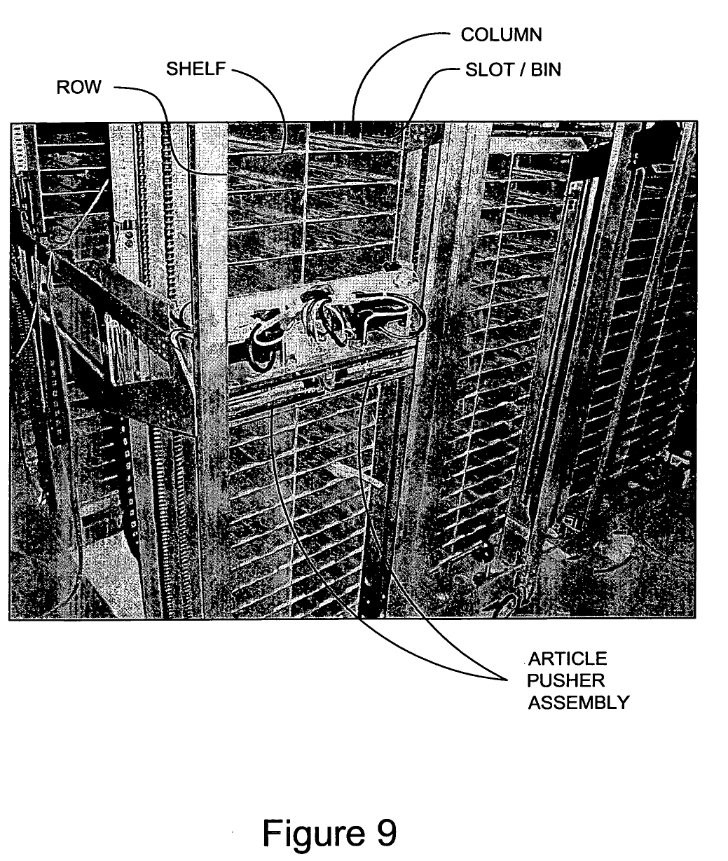

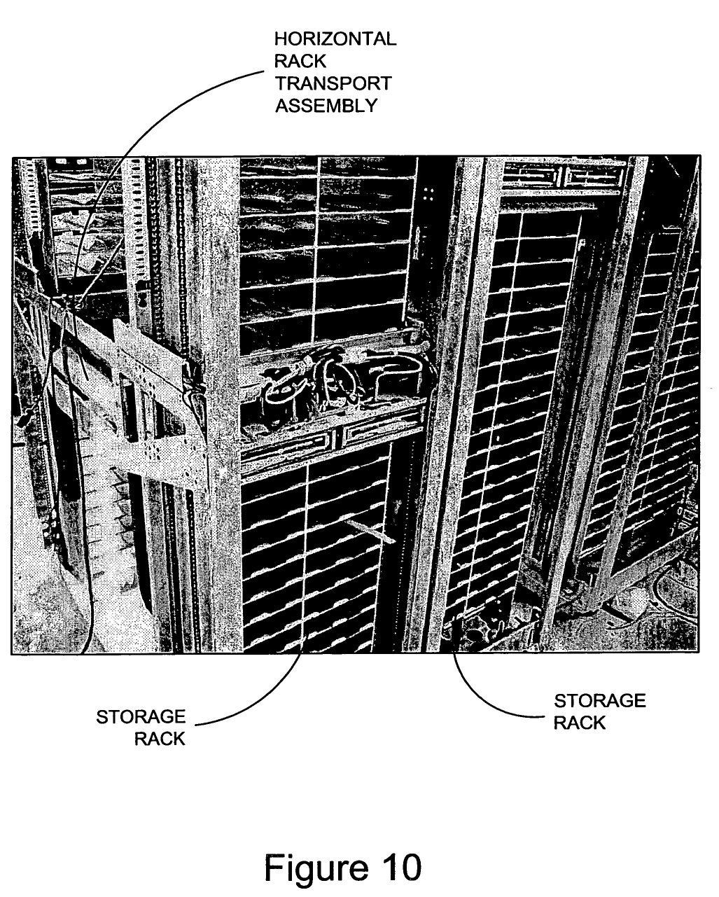

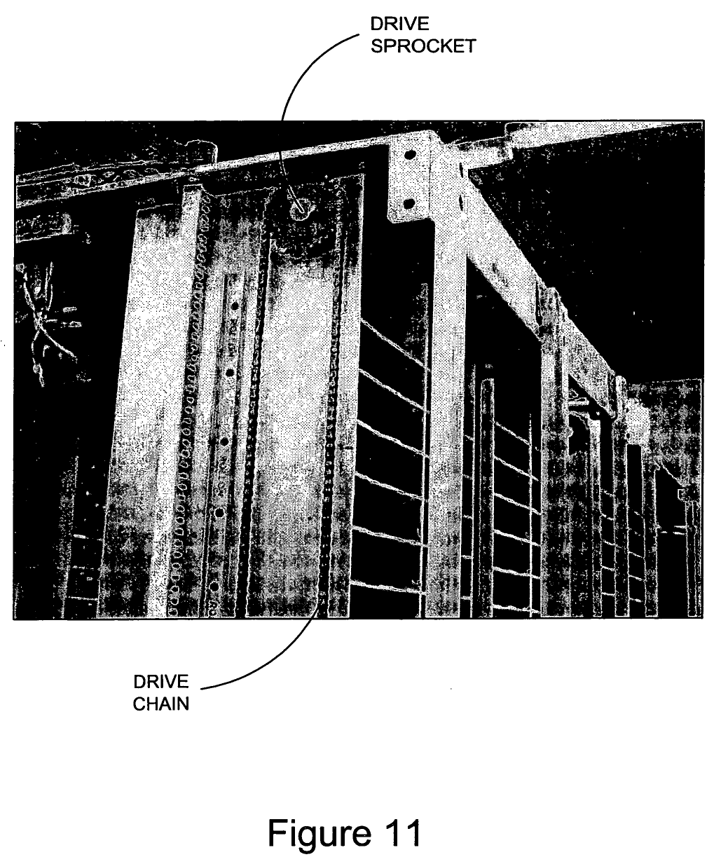

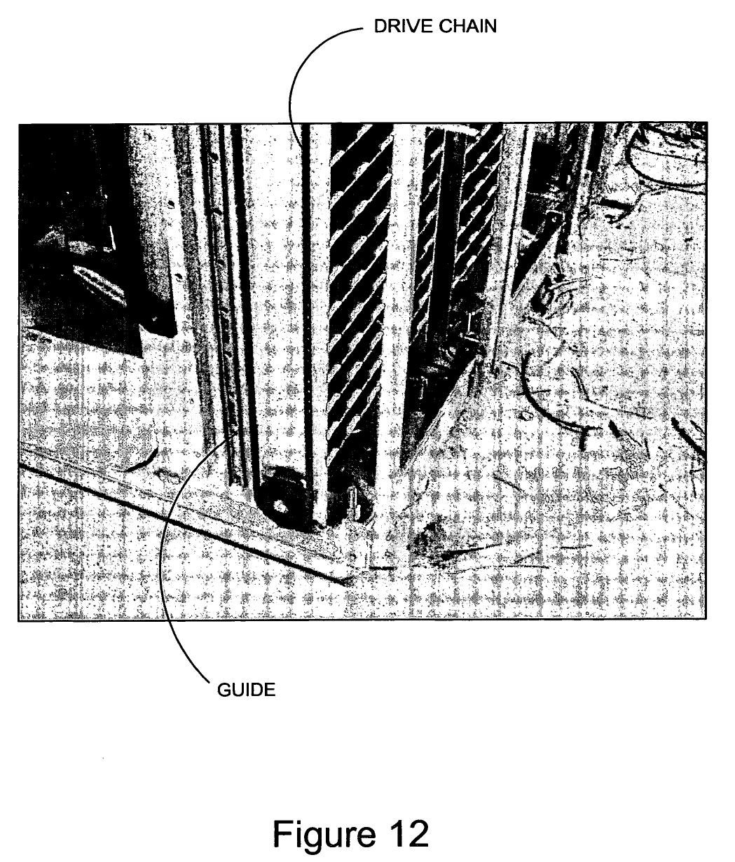

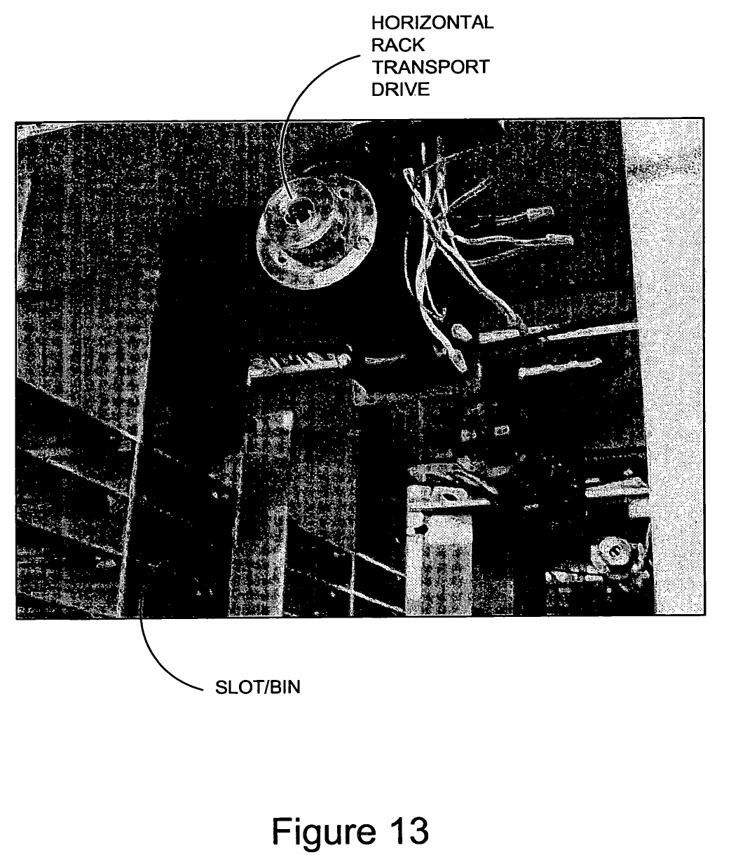

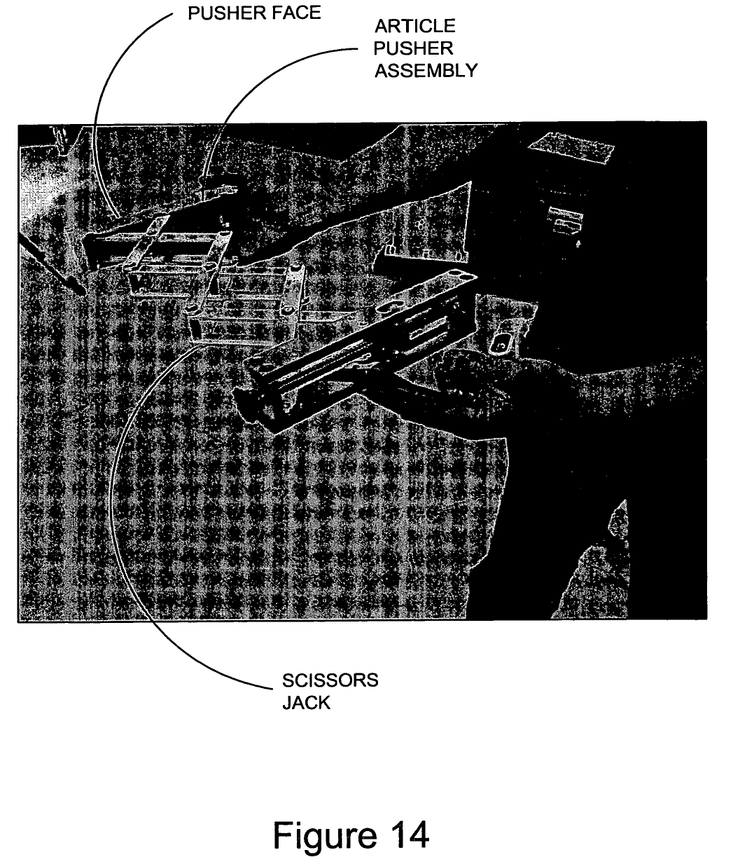

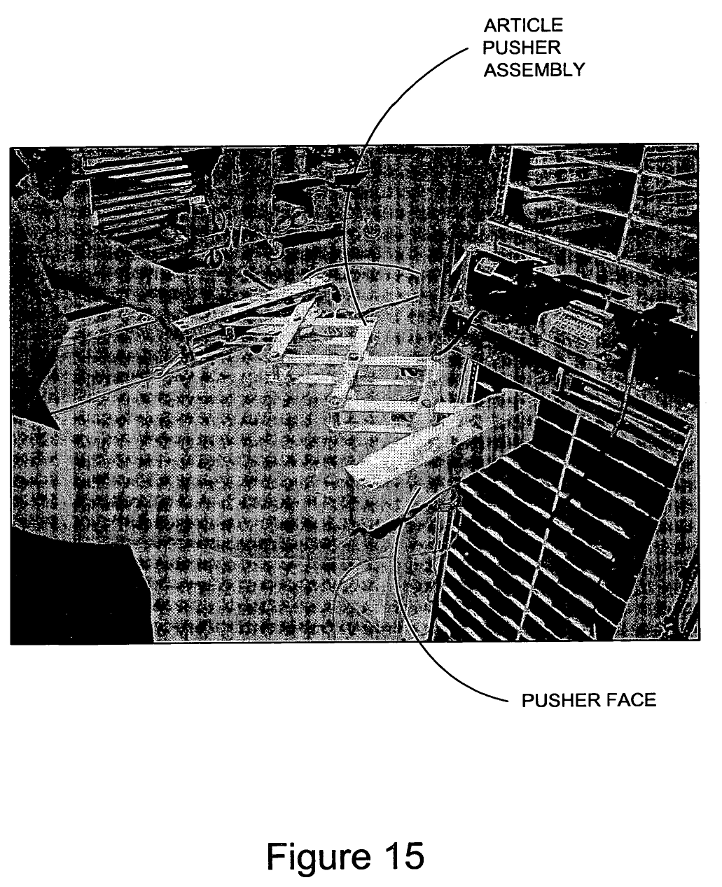

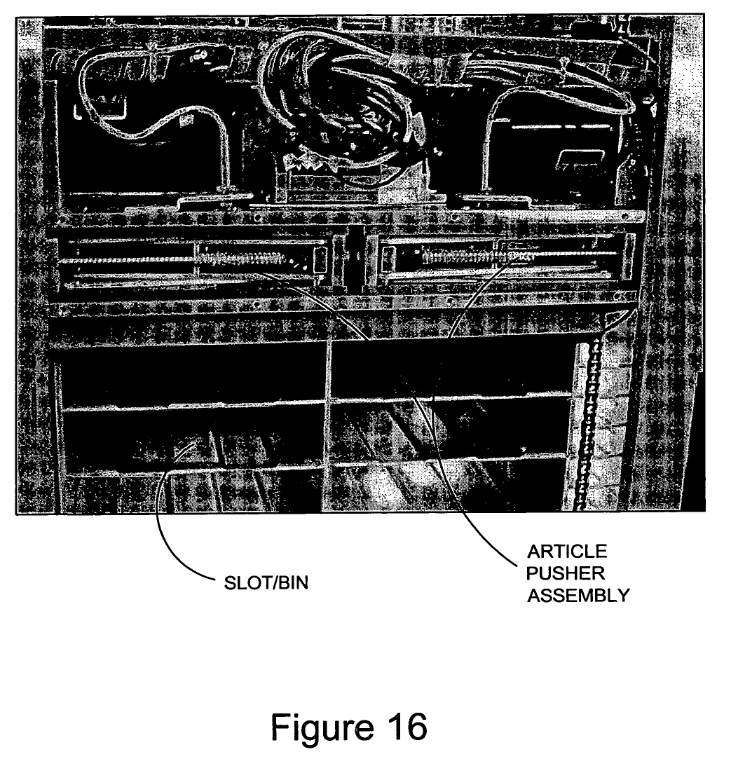

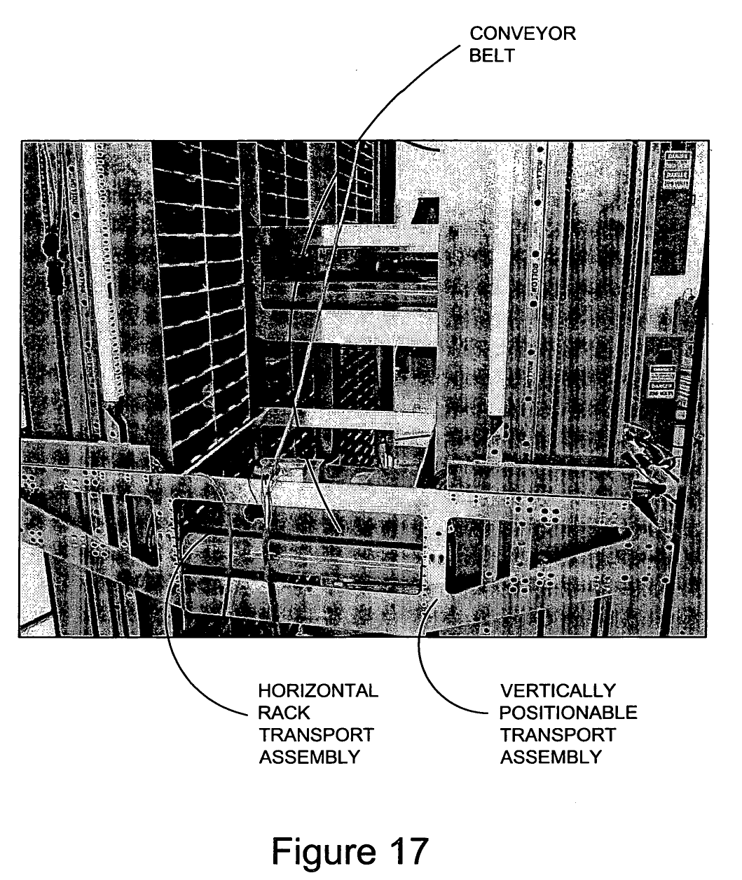

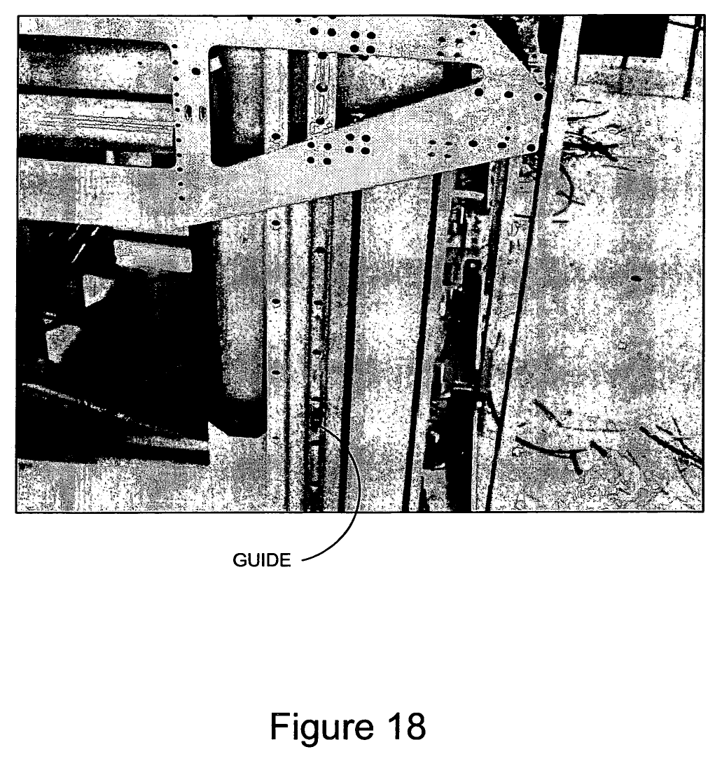

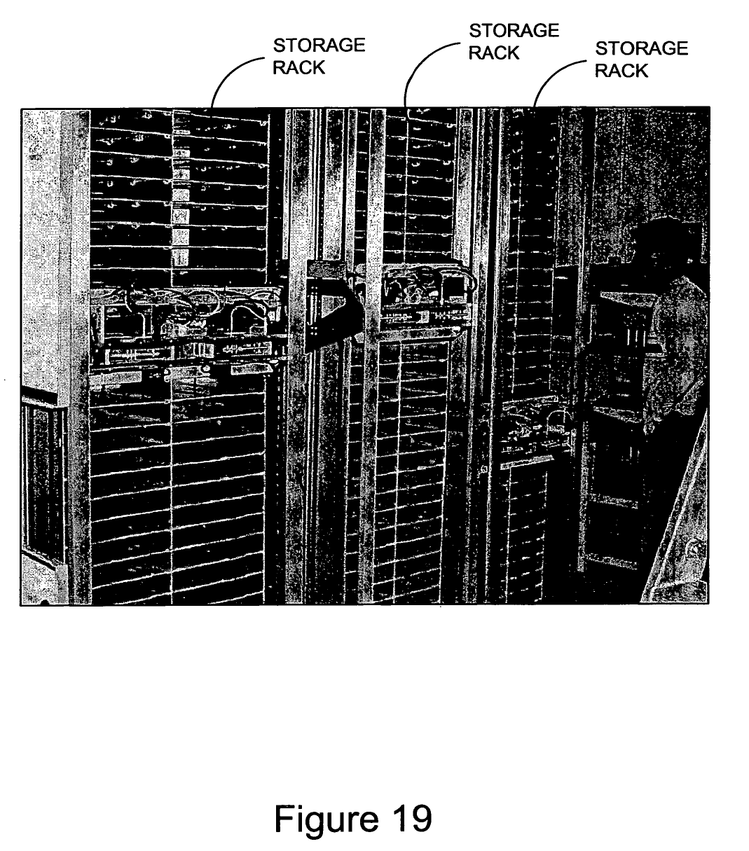

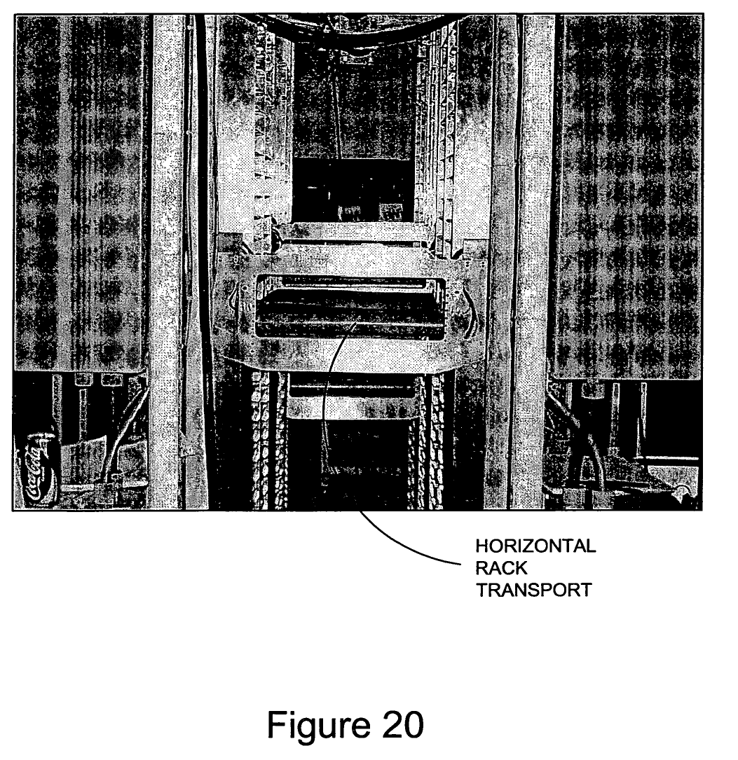

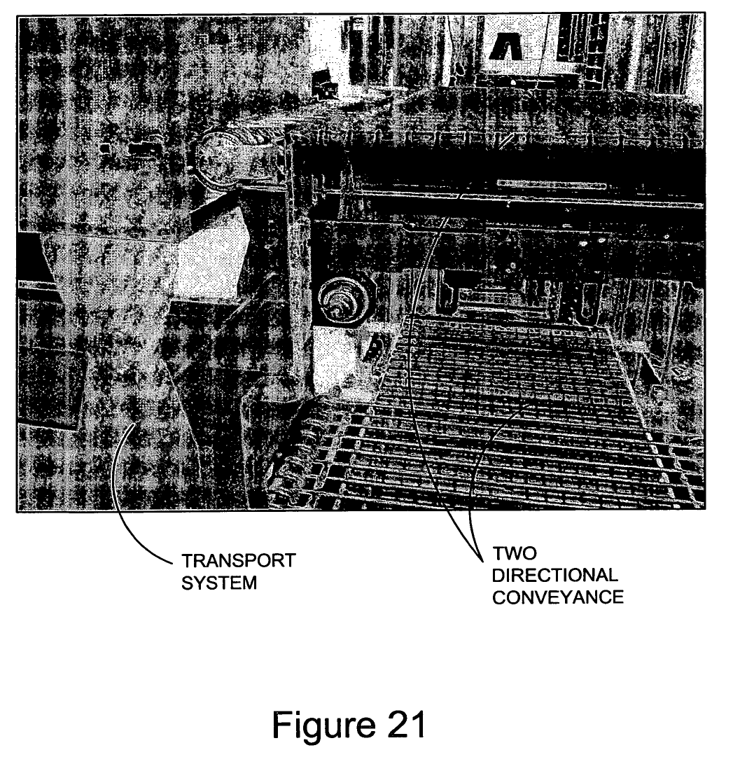

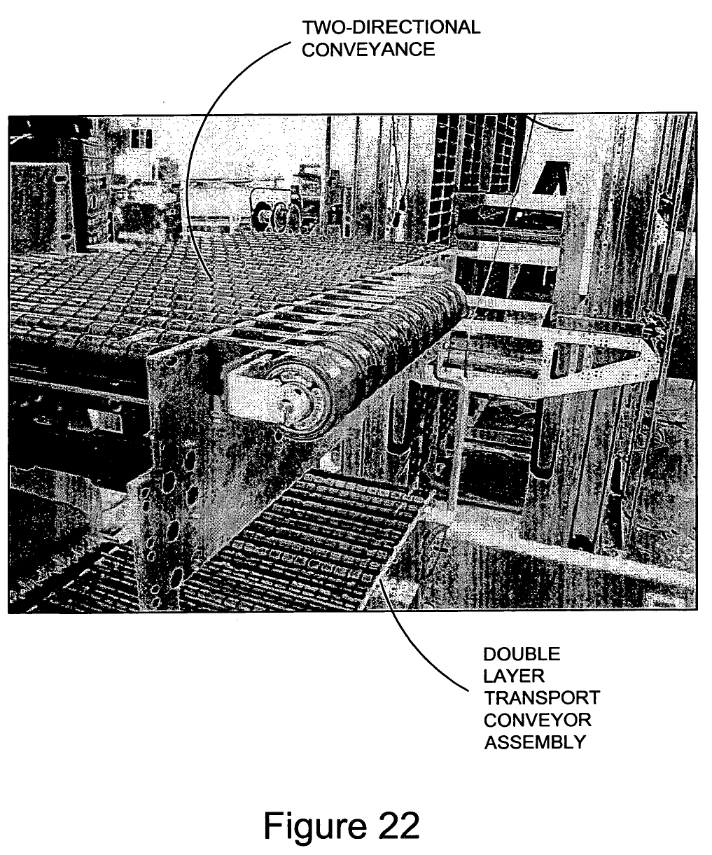

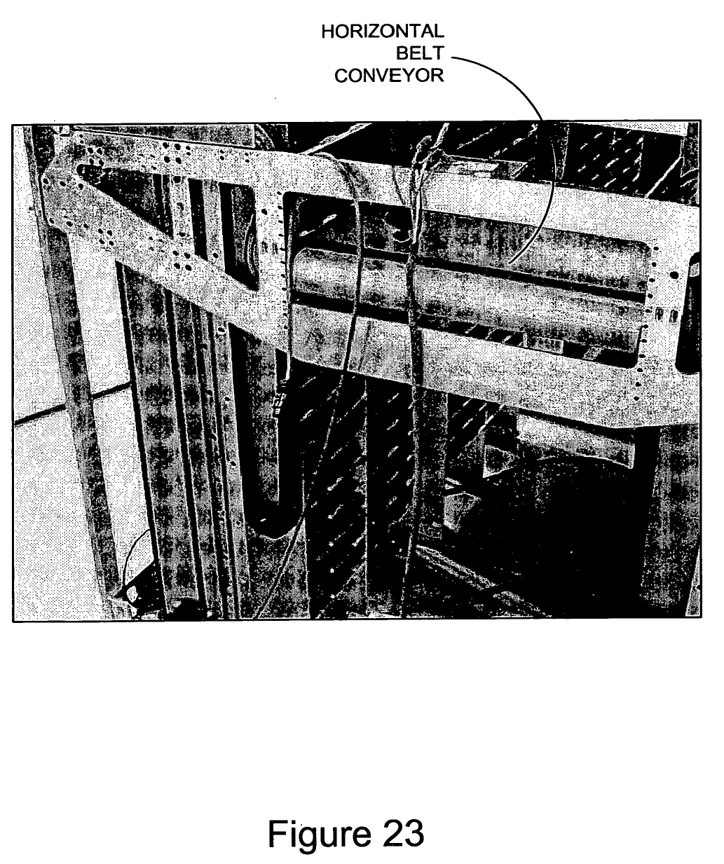

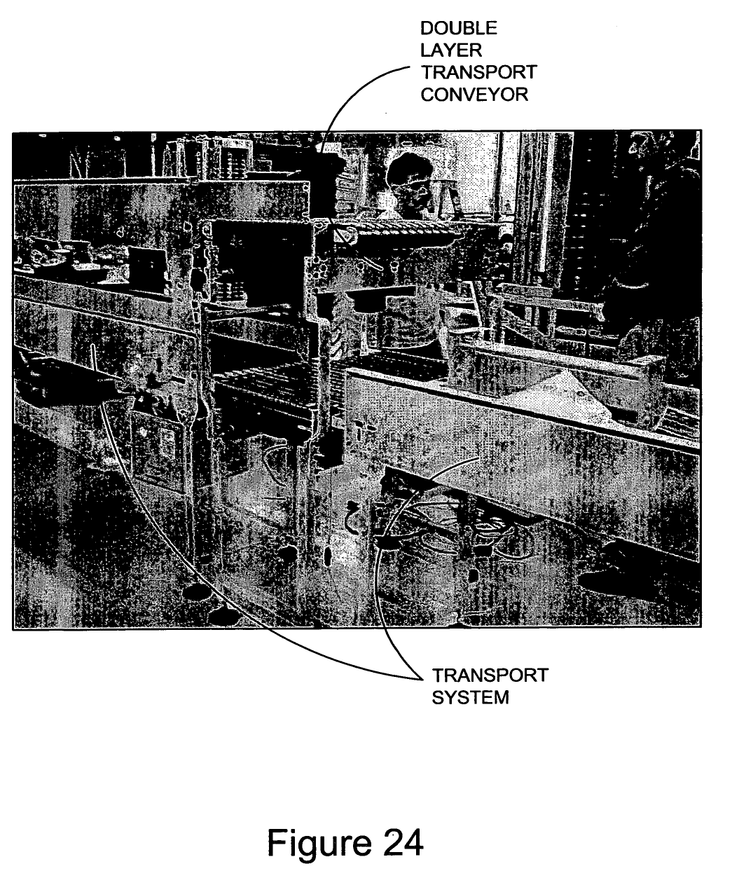

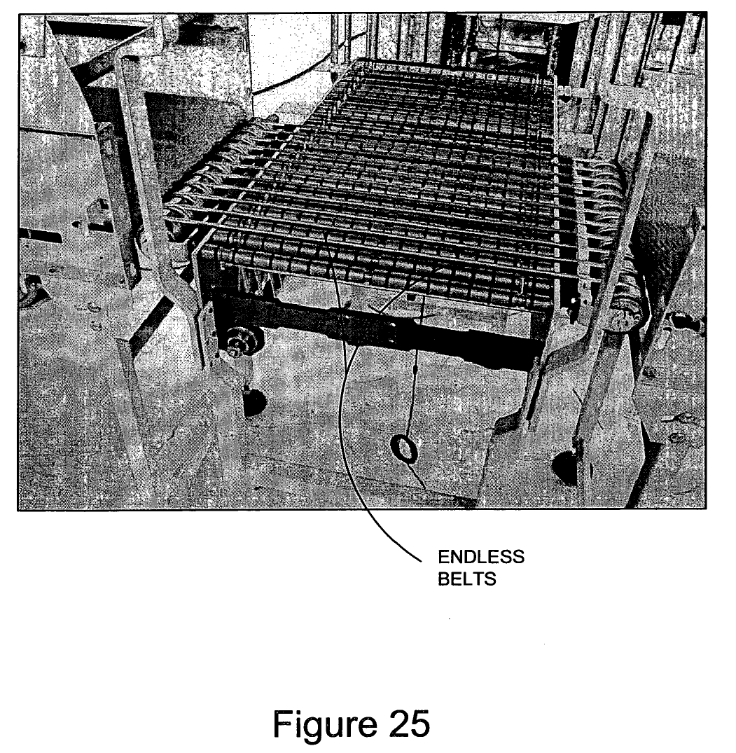

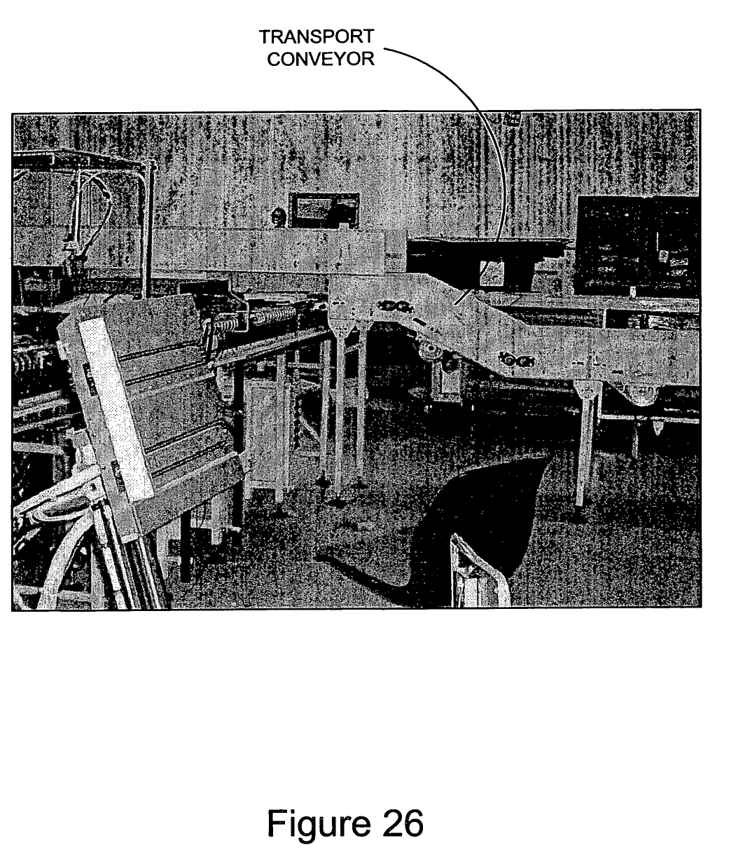

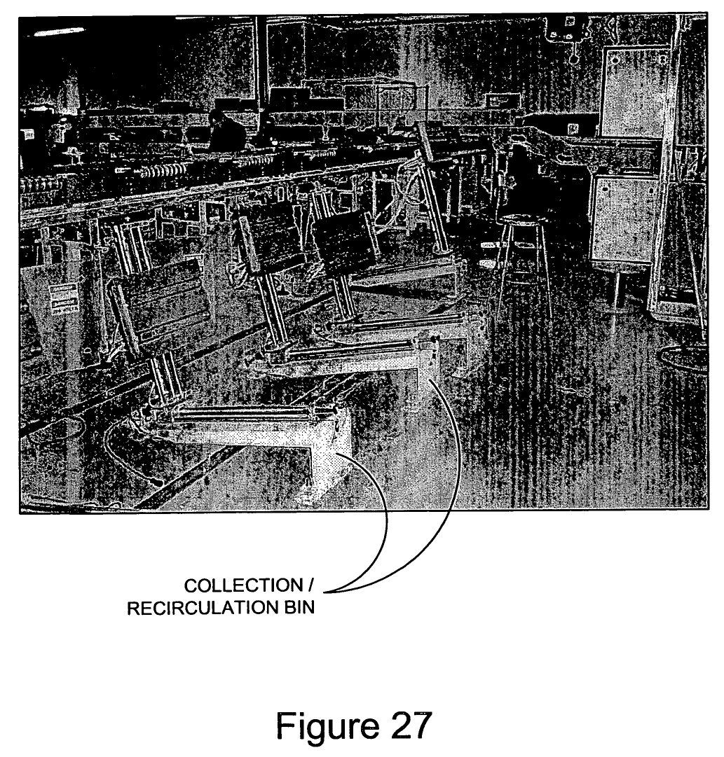

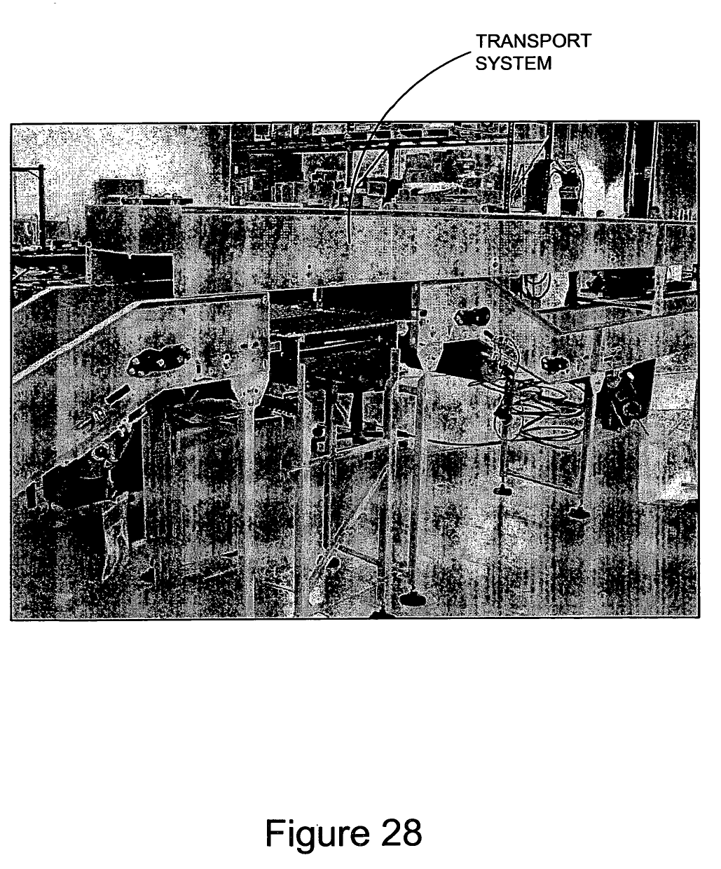

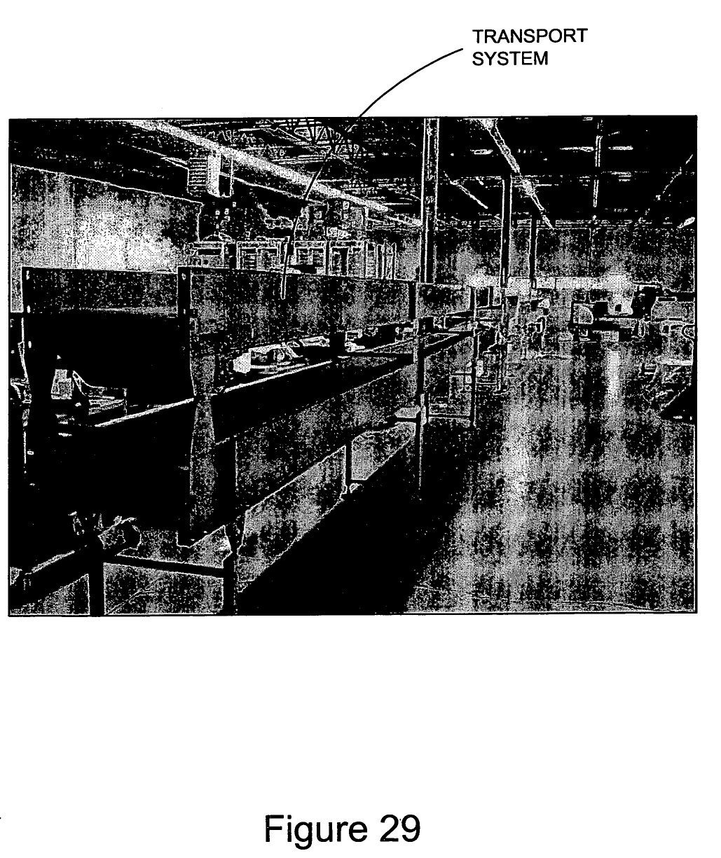

FIG. 7 is a schematic flow diagram illustrating a control scheme for the automatic purging of reserved library articles from the storage bins 118. While in “Standby Mode” (block 700) the system checks the reservation expiration date of all articles stored in cabinet 100 (block 702) If an article is identified with an expired reservation date (block 704) the system initiates “Auto Purge Mode” (block 706.) System controller 101 identifies the article bin_ID 118 (block 708.) System controller 101 moves the vertically positionable retrieve and transport assembly 104 to attain alignment of pusher 134 and designated bin (block 710.) System controller 101 instructs pusher 134 to push the article out of the designated bin (block 712.) After pusher 134 has returned to its “home” position (block 714.), vertically positionable retrieve and transport assembly 104 moves to attain alignment of horizontal transport assembly 130 and exit conveyor 242 (block 716.) Conveyor 242 transports the article to conveyor 248. Conveyor 248 transports the article to a re-circulation collection bin (block 718.) The system controller CPU 101 ends “Auto Purge Mode” (block 720) and begins “Standby Mode” (block 722.) After “Standby Mode ”has begun, the aforementioned sequence repeats.

Although not shown, rack assembly. 100 includes an automated light curtain provided at both the forward and rearward ends of the rack such that if the light curtain is broken by way of a human operator or article, the system is disable until such time that the fault has been corrected.

It should be understood that the aforedescribed control scheme may be controlled by a computerized control system such as a computer workstation or the like. Although the operation and control of rack assembly 100, transport system 246, and conveyor assembly 240 of the present invention has been described herein in simple control terms and concepts, it should be appreciated that alternative or more complex controls and systems are all within the true spirit and scope of the present invention as claimed herein.

While the present invention has been particularly shown and described with reference to the accompanying figures it will be understood, however, that other modifications thereto are of course possible, all of which are intended to be within the true spirit and scope of the present invention. It should be appreciated that components of the invention aforedescribed may be substituted for other suitable components for achieving similarly desired results.

Further, it will be appreciated by those skilled in the art that any suitable conveyance or transport technique may be substituted for output conveyor belts 132, 248, and 250. Such techniques may include rolling or sliding beds or shuttles, a fixed roller bed, or even simply a low-friction surface for sliding movement of articles thereupon. Further, any number of conveyor belts could be substituted for belts 132, 248, and 250.

With regard to system controller 101, various other functions could be provided thereby. For instance, various fault states of the system could be identified and announced by an alarm incorporated with system controller 101, or such fault states could additionally be transmitted by system controller 101 to a library computer workstation for logging and diagnostic uses.

As will be apparent to those skilled in the art, while the system is in “Standby Mode” an internal programming function may check article reservation expiration dates. Further apparent is there need not be a conveyance separating two racks. Only one rack with a conveyance may indeed be feasible to those skilled in the art.

It is to be appreciated that rack assembly 100 is intended to be located in a secure area of, for example, a library where access is limited to library personnel.

Lastly, the choice of mechanical sizes and strengths of various components are all a matter of design choice depending upon intended use and objects intended to be handled by the system of the present design.

Accordingly, these and other various changes or modifications in form and detail of the present invention may also be made therein, again without departing from the true spirit and scope of the invention as defined by the claims.

1. A library article reserve delivery system wherein a patron requested library article awaits retrieval by the patron comprising:
at least one rack having at least one vertical column of shelves for holding library articles, where a central reference axis passes through an upper surface of each of said shelves, and where each shelf extends from a forward end to rearward end thereof, and where each of said shelves forms, in part, a slot having an open forward end thereof and a rearward end thereof, and where each of said shelves is assigned a unique self identifier;
a vertically positionable retrieve and transport assembly coupled to said rack capable of being vertically positioned relative to a selected one of said vertical column of shelves and corresponding slot in response to a transport command signal, said vertically positionable retrieve and transport assembly including,
an article pusher assembly, responsive to a pusher command signal adapted for pushing any articles on said selected one shelf through said rearward open end of said selected slot associated with said selected one shelf; and
a transport conveyor assembly including a transport conveyor belt adapted to be positioned relative to the corresponding rearward open end of said selected slot for receiving any articles pushed therefrom and transporting any received articles thereon in a direction transverse to said central axis of said shelves;
for transporting article thereon from a forward end to rearward end thereof, and, said transport conveyor being adapted to be in proximity to said rearward open ends of said slots for receiving any articles pushed from rearward end of said slots, and
a transport conveyor assembly for transporting article thereon from a forward end to rearward end thereof, and in a direction transverse to said central axis of said shelves, said transport conveyor being adapted to be in proximity to said rearward open ends of said slots for receiving any articles pushed from rearward end of said slots, and
a data processing means for storing patron reserve information including a shelf identifier, library article identifying information associated with any articles on any shelf, and patron identifying informnation;
a control system coupled to said data processing means responsive to a patron request for retrieving a reserved library article for successively generating,
a first vertical transport command signal so that said vertically positionable retrieve and transport assembly is positioned such that said transport conveyor and said pusher assembly are aligned with respect to a selected shelf having a specific identifier,
a pusher command signal such that pusher assembly pushes any articles on said selected shelf onto said transport conveyor;
a second vertical transport command signal so that said vertically positionable retrieve and transport assembly is positioned to a selected exit position relative to said column of shelves, and
a transport conveyor command signal so as to initiate transport of any articles on said transport conveyor belt toward a patron

2. A method of delivering a patron requested reserved library article comprising the steps of:
placing requested library articles on a selected shelf of a rack having at least one vertical column of shelves for holding library articles, where a central reference axis passes through an upper surface of each of said shelves, and where each shelf extends from a forward end to rearward end thereof, and where each of said shelves forms, in part, a slot having an open forward end thereof for receiving manually placed library articles therein, and a rearward end thereof, and where each of said shelves is assigned a unique self identifier;
vertically positioning an article pusher assembly in proximity to a selected shelf and corresponding selected slot having articles reserved by said patron therein, said article pusher assembly adapted for pushing any articles on a selected shelf through said rearward open end of said selected slot;
vertically positioning a transport conveyor belt assembly in proximity to said rearward open end of said corresponding selected slot for receiving any articles pushed therefrom onto said transport conveyor belt assembly, said transport conveyor belt assembly capable of transporting any articles thereon from a forward end to rearward end thereof, and in a direction transverse to said central axis of said shelves in response to a conveyor command signal;
vertically positioning said transport conveyor to an exit position relative to said column of shelves in response to a second vertical transport command signal, and
initiating said transport conveyor in response to a conveyor command signal so as to initiate transport of any articles on said transport conveyor belt assembly.

3. A library material handling system for at least selectively (i) delivering library articles to a re-circulation and re-shelving article handling system, and (ii) delivering patron reserved library articles to a patron delivery system in response to a patron request for subsequent receiving by the patron, the system comprising:
a first library article transport conveyor for transporting articles from receiving station to an article recirculation and re-shelving station;
a second library transport conveyor system for transporting articles from a reserve article storage station to a patron article receiving station;
and
wherein said reserve article storage station includes, at least one rack having at least one vertical column of shelves for
holding library articles, where a central reference axis passes through an upper surface of each of said shelves, and where each shelf extends from a forward end to rearward end thereof, and where each of said shelves forms, in part, a slot having an open forward end thereof and a rearward end thereof, and where each of said shelves is assigned a unique self identifier;
a vertically positionable retrieve and transport assembly coupled to said rack capable of being vertically positioned relative to said vertical column of shelves in response to a transport command signal, said vertically positionable retrieve and transport assembly including,
an article pusher assembly responsive to a pusher command signal adapted for pushing any articles on said selected one shelf through said rearward open end of said selected slot associated with said selected one shelf; and
a transport conveyor assembly including a transport conveyor belt adapted to be positioned relative to the corresponding rearward open end of said selected slot for receiving any articles pushed therefrom and transporting any received articles thereon in a direction transverse to said central axis of said shelves;
a data processing means for storing patron reserve information including a shelf identifier, library article identifying information associated with any articles on any shelf, and patron identifying information;
a control system coupled to said data processing means responsive to a patron request for retrieving a reserved library article for successively generating,
a first vertical transport command signal so that said vertically positionable retrieve and transport assembly is positioned such that said transport conveyor and said pusher assembly are aligned with respect to a selected shelf having a specific identifier,
a pusher command signal such that pusher assembly pushes any articles on said selected shelf onto said transport conveyor;
a second vertical transport command signal so that said vertically positionable retrieve and transport assembly is positioned to a selected exit position relative to said column of shelves, where said exit position is selectively aligned with said a receiving station associated with said first library article transport conveyor for transporting an article from said rack to a patron, and a receiving station associated with said second library article transport conveyor for transporting an article from said rack to said recirculation and re-shelving station.
